(19) United States
(12) Patent Application Publication
(10) Pub. No.: US 2011/0292052 A1
(43) Pub. Date: Dec. 1, 2011

(54) CAPTION-GENERATING METHOD FOR REPRESENTING PITCH, AND CAPTION DISPLAY METHOD

(76) Inventor: Sung Ji Choi, Seoul (KR)

(21) Appl. No.: 13/147,063

(22) PCT Filed: Jul. 29, 2010
(86) PCT No.: PCT/KR10/04984

§ 371 Date: Jul. 29, 2011

(30) Foreign Application Priority Data
Aug. 17, 2009 (KR) 10-2009-0075522

(51) Int. Cl. G06T 11/00

(52) U.S. Cl. 345/467

(57) ABSTRACT

Provided is a method of generating a caption using lyrics caption data to display a lyrics caption in synchronization with audio data. The method includes dividing the audio data into a plurality of reference sections, extracting a reference note from notes of the audio data within each of the reference sections, setting a reference position corresponding to the reference note within a caption display area of a whole screen where the lyrics caption is to be displayed in a vertical direction, and generating the lyrics caption data such that a lyrics caption corresponding to the reference note within one of the reference sections is displayed on the reference position of the caption display area, and other lyrics captions within the one of the reference section are vertically displayed within the caption display area according to pitch differences from the reference notes.

### TECHNICAL FIELD

The present invention relates to a method of generating and displaying caption using lyrics caption data. In particular, the following disclosure relates to a method of generating and displaying caption using lyrics caption data, which can visually represent the pitch of a sound using lyrics caption displayed in synchronization with audio data.

### BACKGROUND ART

Recently, methods for reproducing audio have been developed into hardware methods using CD players, DVD players, and MP3 players and software methods such as various types of audio players installed in a computer. Also, accompaniment devices such as karaoke machines are being widely used to reproduce audio.

In reproduction of songs such as popular songs and children's songs, technology of displaying lyrics of the songs on a screen has been developed from machine of a singing room or a karaoke. Due to distribution of portable multimedia devices such as Personal Digital Assistant (PDA) and Portable Multimedia Player (PMP) having a screen such as Liquid Crystal Display (LCD), technology of displaying lyrics during the reproduction of songs has been steadily developed.

For example, in case of videos such as music videos, video and audio may be provided in a format of avi file, and lyrics caption may be provided in a format of smi file. Thus, technologies of allowing a user to view lyrics while watching a music video are being widely distributed.

However, in a related-art method for displaying a lyrics caption on a screen, a karaoke machine has only a function of displaying lyrics of a corresponding song and inverting the color of the lyrics caption at a point when a corresponding part of lyrics has to be sung, but other information of a corresponding song, e.g., pitch and note is not provided to a user.

In order to overcome such a limitation, “Method for Displaying Image Lyrics in Song Accompaniment Instrument” disclosed in Korea Patent Registration No. 540,190 includes technology of providing information on pitches and notes corresponding to lyrics by changing the size of the font of lyrics caption or the location of the lyrics caption on a screen, or displaying other additional images.

However, the technology described above is not expected to have a significant effect due to the following limitations even when it is commercialized.

First, when the pitch is represented using a caption image, the size or the location of the caption image on a screen is changed according to the absolute value of a corresponding pitch. Accordingly, there is a limitation for a user to visually recognize the pitch.

For example, in order to represent the pitch on a musical score by controlling the vertical location of the caption on the screen, the height of the caption has to be divided into 24 steps in the case of two octaves including semi-tone and 36 steps in the case of three octaves including semi-tone. Accordingly, when a certain area of the screen on which the lyrics caption is to be displayed is divided into 24 steps or 36 steps, there is a difficulty in visually verifying a difference between pitches.

In order to overcome such a limitation, the above-described cited reference discloses a method of implementing four or six caption heights by grouping 16 notes of two octaves into four categories and 24 notes of three octaves into six categories to represent the pitch by controlling the vertical location of the lyrics caption.

However, in the cited reference, two octaves are assumed to have 16 notes, and are grouped into four categories having 4 notes per group. However, this disregards a semitone. 6 notes are substantially involved in one category.

Also, there are limitations in that the lyrics caption is usually displayed on the screen syllable by syllable and there are few songs in which the pitch rapidly changes in one syllable. In addition, there is no effectiveness in that a pitch difference between adjacent notes usually includes a semitone within one to five steps.

FIG. 1 illustrates notes of 36 steps grouped into six categories. In the drawing, a children's song, ‘Hak-Gyo-Jong-Ee-Ding-Ding-Dang’ (‘ [symbol] ’) has a beginning part of ‘sol-sol-la-la-sol-sol-me’ in which the lowest pitch is ‘E (mi)’ and the highest pitch is ‘A (la)’. There are six steps between the highest and lowest pitches. Accordingly, when notes of 36 steps are grouped into six categories, and the reference thereof is set to ‘E (mi)’, ‘Hak-Gyo-Jong-Ee-Ding-Ding-Dang’ is all represented at the same pitch. Also, even when the reference thereof is set to a note other than ‘E (mi)’, only two pitches exist.

In FIG. 1, the reference is set to C (do) and F# (pa#) of each octave. ‘Hak-Gyo-Jong-Ee-Ding-Ding’ (‘ [symbol] ’) of the caption is represented as the same height, and the last part, ‘Dang’ (“ [symbol] ”) is represented as a group below by one step. On the other hand, in order to represent a pitch difference ‘Hak-Gyo-’ and ‘Jong-Ee-’, if sol# (G#) is set as a reference, the last part ‘Ding-Ding-Dang’ has to be all represented at the same height. Accordingly, it may cause confusion to a user rather than represent the pitch of notes. As a result of analyzing various songs, a part of about 80% or more among the total caption has been verified to be displayed regardless of the actual pitch of notes.

### DISCLOSURE

### Technical Problem

Accordingly, the present invention provides a method of generating and displaying caption using lyrics caption data, which can visually represent the pitch of a sound using lyrics caption displayed in synchronization with audio data.

### Technical Solution

In one general aspect, a method of generating a caption using lyrics caption data to display a lyrics caption in synchronization with audio data includes: dividing the audio data into a plurality of reference sections; extracting a reference note from notes of the audio data within each of the reference sections; setting a reference position corresponding to the reference note within a caption display area of a whole screen where the lyrics caption is to be displayed in a vertical direction; and generating the lyrics caption data such that a lyrics caption corresponding to the reference note within one of the reference sections is displayed on the reference position of the caption display area, and other lyrics captions within the one of the reference section are vertically displayed within the caption display area according to pitch differences from the reference notes.

In some embodiments, the extracting of the reference note may include extracting a lowest-pitched note of the audio data within the respective reference sections as the reference note, and the setting of the reference position may include setting the reference position as a lowest position of the caption display area corresponding to the lowest-pitched note.

In other embodiments, the extracting of the reference note may include extracting a highest-pitched note of the audio data with the respective reference sections as the reference note, and the setting of the reference position includes setting the reference position as a highest position of the caption display area corresponding to the highest-pitched note.

In still other embodiments, the extracting of the reference note may include extracting a highest-pitched note and a lowest-pitched note of the audio data with the respective reference sections as the reference note, and the setting of the reference position may include setting the reference position as a highest position of the caption display area corresponding to the highest-pitched note and a lowest position of the caption display area corresponding to the lowest-pitched note, respectively.

In even other embodiments, the setting of the reference position may include setting a plurality of display positions including the reference position in the caption display area, and the generating of the lyrics caption data may include generating the lyrics caption data such that the other captions are displayed on any one of the plurality of display positions according to the pitch differences from the reference note.

In yet other embodiments, the generating of the lyrics caption data may include generating the lyrics caption data such that a letter spacing of the lyrics caption displayed in the one of the reference sections corresponds to a relative length of a note with respect to the corresponding lyrics caption.

In other embodiments of the present invention, methods of generating a caption using lyrics caption data to display a lyrics caption in synchronization with audio data include: reproducing the audio data in synchronization with the lyrics caption data; sequentially displaying the lyrics caption extracted from the lyrics caption data on a screen by unit of predetermined reference section; and displaying the lyrics caption displayed in one of the reference sections on the screen such that relative pitch differences of notes within a reference section corresponding to the audio data reproduced during the reference section are visually distinguished.

In some embodiments, in the displaying of the lyrics caption, a reference note corresponding to a predetermined reference position among the one of the reference sections may be displayed in the reference position within a caption display area in which the lyric caption is to be displayed in a vertical direction, and other lyrics captions within the one of the reference section may be vertically displayed within the caption display area according to pitch differences from the reference notes.

In other embodiments, the reference position may be set to a lowest position of the caption display area, and the reference note may be set to a lowest-pitched note within the one of the reference section.

In still other embodiments, the reference position may be set to a highest position of the caption display area, and the reference note may be set to a highest note within the one of the reference sections.

In even other embodiments, the reference position may be set to a highest position and a lowest position of the caption display area, and the reference note may be set to a highest note and a lowest note within the one of the reference sections corresponding to the highest position and the lowest position.

In yet other embodiments, a plurality of display positions including the reference position may be set in the caption display area, and the other captions within the one of the reference sections may be displayed on any one of the plurality of display positions according to the pitch differences from the reference note.

In further embodiments, the displaying of the lyrics caption may include generating the lyrics caption data such that a letter spacing of the lyrics caption displayed in the one of the reference sections corresponds to a relative length of a note with respect to the corresponding lyrics caption.

Other features and aspects will be apparent from the following detailed description, the drawings, and the claims.

### Advantageous Effects

According to an embodiment of the present invention, a method of generating and displaying caption using lyrics caption data, which can visually represent the pitch of a sound using lyrics caption displayed in synchronization with audio data, is provided.

### DESCRIPTION OF DRAWINGS

FIG. 1 is a diagram illustrating a method of generating lyrics caption using lyrics caption data according to a related-art.

FIG. 2 is a flowchart illustrating a method of generating caption using lyrics caption data according to an embodiment of the present invention.

FIGS. 3 and 4 are diagrams illustrating lyrics caption generated by a method for generating caption according to an embodiment of the present invention.

FIG. 5 is a diagram illustrating a multimedia player in which lyrics caption data is reproduced according to an embodiment of the present invention.

FIG. 6 is a diagram illustrating exemplary reproduction of lyrics caption data generated by a caption generation method according to an embodiment of the present invention, using a multimedia player installed in a computer.

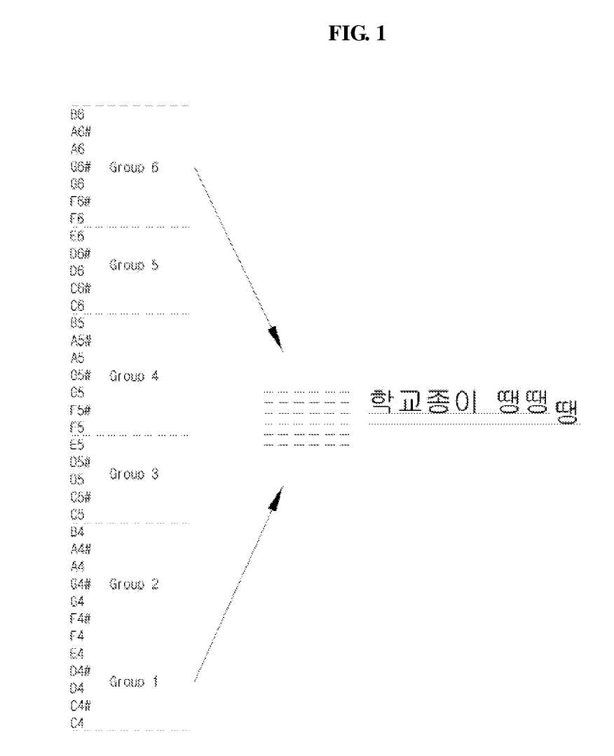

### BEST MODE

The present disclosure relates to a method of generating a caption using lyrics caption data to display a lyrics caption in synchronization with audio data, the method including: dividing the audio data into a plurality of reference sections; extracting a reference note from notes of the audio data within each of the reference sections; setting a reference position corresponding to the reference note within a caption display area of a whole screen where the lyrics caption is to be displayed in a vertical direction; and generating the lyrics caption data such that a lyrics caption corresponding to the reference note within one of the reference sections is displayed on the reference position of the caption display area, and other lyrics captions within the one of the reference section are vertically displayed within the caption display area according to pitch differences from the reference notes.

### MODE FOR INVENTION

Hereinafter, exemplary embodiments will be described in detail with reference to the accompanying drawings. Throughout the drawings and the detailed description, unless otherwise described, the same drawing reference numerals will be understood to refer to the same elements, features, and structures. The relative size and depiction of these elements may be exaggerated for clarity, illustration, and convenience. The following detailed description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

For explanation of the present invention, ‘audio data’ is defined as a concept including formats that can be outputted as actual music. Examples of audio data may include way files digitized from an analog sound, mp3 files or wma files compressed from a digitized sound, and avi files for implementing video. In the present disclosure, midi data will be exemplified as audio data.

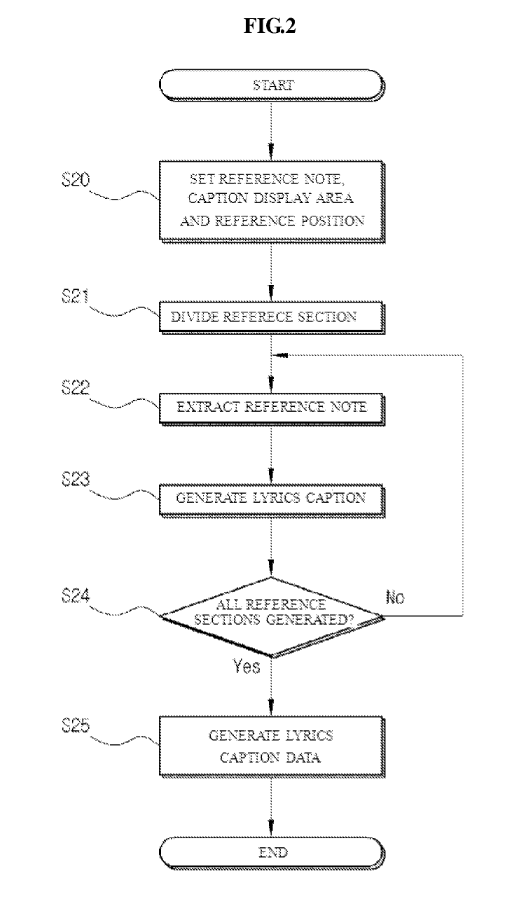

FIG. 2 is a flowchart illustrating a method of generating caption using lyrics caption data according to an embodiment of the present invention. Referring to FIG. 2, a reference note and a caption display area may be determined in operation S20.

Here, a reference section may be a unit by which the lyrics caption data according to an embodiment of the present invention is displayed on a screen. In other words, the reference section means a display unit that is separated from the whole lyrics caption to be displayed on the screen when the lyrics caption data is reproduced in synchronization with audio data according to the reproduction of the audio data. For example, like in a karaoke machine of a singing room, lyrics caption may be displayed in two lines. In this case, each of the two lines corresponding to a currently-reproduced section of audio data may become a reference section. Here, the reference section may be appropriately determined according to the amount of lyrics.

The caption display area means a vertical section of the whole screen on which the lyrics caption is to be displayed when the lyric caption data is displayed on the screen. Here, when the lyrics caption is displayed in two lines like a karaoke machine, the caption display area denotes an area in which upper one of two lines is displayed.

Also, the reference note means a sound that becomes a reference for applying a caption generation method according to an embodiment of the present invention to one reference section among the whole audio data. In the present disclosure, a note having the lowest pitch among sounds of audio data within each reference section will be set to a reference note.

In a state where the reference note, the caption display area, and the reference section are set, a process of generating lyrics caption data to be reproduced in synchronization with audio data regarding a specific song will be described as follows.

In operation S21, audio data may be divided into reference sections. Thereafter, in operation S22, a reference note, i.e., a note having the lowest pitch among sounds within the first reference section may be extracted from the first reference section where the lyrics caption is to be displayed.

In operation S23, a lyric caption may be generated on the basis of the lowest-pitched note extracted from the first reference section. More specifically, a lyrics caption corresponding to the lowest-pitched note, i.e., the reference note within the reference section may be displayed on a reference location of the caption display area, and other captions may be vertically displayed in the caption display area according to pitch differences from the reference note.

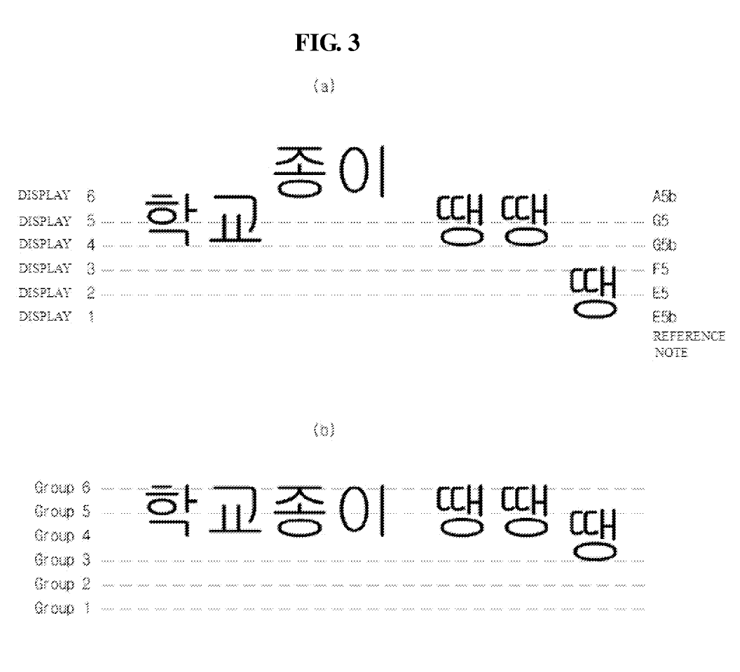

To explain more specifically with reference to FIG. 3A, in the present embodiment, the caption display area is divided into a plurality of display positions. In FIG. 3A, the caption display area is divided into 6 display positions, but embodiments are not limited thereto.

Here, when the reference note extracted from one reference section is the lowest note, the lowest position of the display positions of the caption display area may become a reference position where a lyrics caption corresponding to the reference note is to be displayed. The lyrics caption may be allowed to be displayed on 6 display positions at an interval of semitone. Accordingly, the lyrics caption corresponding to one reference section can represent 6 notes.

FIG. 3A illustrates the lyrics caption of a children's song, ‘Hak-Gyo-Jong-Ee-Ding-Ding-Dang’ displayed on a screen by a caption generation method according to an embodiment of the present invention. The pitches of ‘Hak-Gyo-Jong-Ee-Ding-Ding-Dang’ of the song are G (sol)-G (sol)-A (la)-A (la)-E (mi), respectively, and the note, ‘E (mi)’ having the lowest pitch may become a reference note. A part of the lyric caption, ‘Dang’ corresponding to the reference note ‘mi’ may be displayed on the lowest position of the display position. The display positions may be spaced by a semitone per interval from the lowermost reference position. The note ‘sol’ may be displayed on the fourth display position from the lowermost reference position, and the note ‘la’ may be displayed on the sixth display position from the lowermost reference position.

FIG. 3B shows a lyrics caption on the caption display area identical to that in FIG. 3A. Also, FIG. 3B shows that notes of 36 steps are grouped into six categories according to “Method for Displaying Image Lyrics in Song Accompaniment Instrument” disclosed in Korea Patent Registration No. 540,190. It can be verified that the lyrics caption generated by the caption generation method according to the present invention is visually recognized, and the lyrics caption having different pitches is clearly displayed.

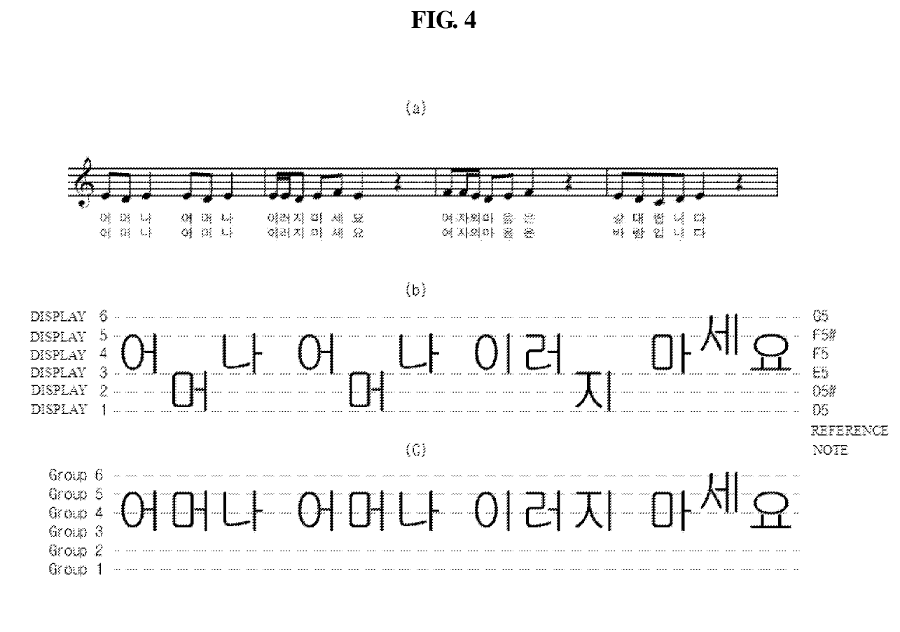

Also, FIG. 4A shows the introduction of a popular song, ‘Oh No No’. FIG. 4B shows a lyrics caption generated using the popular song of FIG. 4A by a caption generation method according to an embodiment of the present invention. FIG. 4C shows a lyrics caption generated by “Method for Displaying Image Lyrics in Song Accompaniment Instrument” disclosed in Korea Patent Registration No. 540,190. As shown in FIG. 4, the lyrics caption generated by the caption generation method according to an embodiment of the present invention may be displayed such that the pitches of sounds can be visually recognized. Also, the lyrics caption having different pitches may be distinctively displayed.

Referring again to FIG. 2, when the lyrics caption of one reference section is generated by the above method, other lyric captions regarding the reference sections may be generated through operations S22 and S23. In operation S24, when the lyrics caption is generated in all reference sections, lyrics caption data including the whole lyrics caption may be generated in operation S25.

Here, the lyrics caption data according to an embodiment of the present invention may be generated in a file format that is physically separated from audio data. For example, audio data according to an embodiment of the present invention may be provided in a form of audio file (including video data) such as avi files and wmv files, and the lyrics caption data may be provided in a form of a caption file that is reproduced in synchronization with an audio file.

In this case, the lyrics caption data according to an embodiment of the present invention may be generated in a substation alpha (ssa) file or an advanced ssa (ass) file. In other words, the lyrics caption data may be provided as a caption file that can perform a karaoke function or control the height of the caption on a screen. Here, when the lyrics caption data according to an embodiment of the present invention can perform a karaoke function of control the height of the caption, the lyrics caption data can be generated in another format of caption file.

Also, the lyrics caption data may be provided in a multimedia file format that is physically combined with audio data. For example, the lyrics caption data and the audio data (including video data) may be combined with each other to generate one file format, for example, mka file or mkv file.

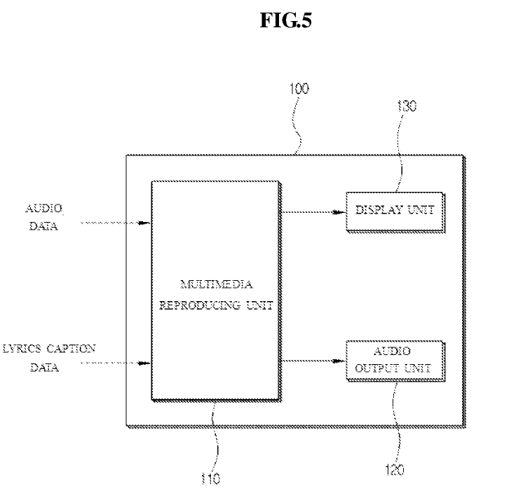

FIG. 5 is a diagram illustrating a multimedia player in which lyrics caption data is reproduced according to an embodiment of the present invention. In FIG. 5, lyrics caption data and audio data generated by the above process are reproduced by a multimedia player 100 to be displayed on the screen.

The multimedia player 100 may include a multimedia reproduction unit 110 for reproducing audio data and lyrics caption data, a display unit 130 for displaying an image including lyrics caption, and an audio output unit 120 for outputting audio data reproduced by the multimedia reproduction unit 110.

Here, the multimedia player 100 may further include a hardware unit including the display unit 130 for displaying the lyrics caption like a CD player, a DVD player, and an MP3 player, and a software unit that can be installed in a computer like various kinds of multimedia players. Also, the multimedia player 100 may include a karaoke machine that can be used for accompaniment in a singing room.

Also, sound sources such as music videos may be reproduced by the multimedia player 100 through downloading or streaming service. Also, lyrics caption generated by the lyrics caption generation method according to an embodiment of the present invention can be displayed even when the lyric caption is displayed in a music program of television broadcasting,

The lyric caption data and the audio data may be generated in various formats of files according to the multimedia player 100 to be reproduced by the multimedia player 100.

When the lyrics caption data and the audio data are reproduced by the multimedia player 100 according to an embodiment of the present invention, the lyrics caption extracted from the lyrics caption data may be sequentially displayed on the screen of the display unit 130 in synchronization with the audio data by unit of the reference section.

In this case, the lyrics caption displayed in one reference section may be displayed on the screen such that the relative pitch difference between notes within the corresponding reference section of the audio data that is reproduced in the corresponding reference section can be visually recognized. In other words, the lyrics caption corresponding to the respective reference section may be sequentially displayed like in FIGS. 3A and 4B.

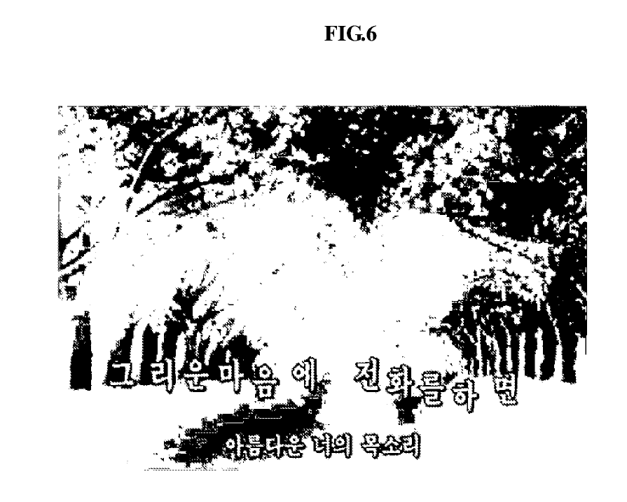

FIG. 6 is a diagram illustrating exemplary reproduction of lyrics caption data generated by a caption generation method according to an embodiment of the present invention, using a multimedia player installed in a computer.

On the other hand, in the caption generation method according an embodiment of the present invention, a letter spacing of the lyrics caption displayed in one reference section may correspond to the relative length of a note with respect to the corresponding lyrics caption.

In other words, since the letter spacing of the lyrics caption may be determined according to the relative length of notes within one reference section, not the absolute length of notes regarding the respective lyrics captions, the horizontal space of the screen may be more efficiently used in that the lyrics caption of the same number is displayed.

In the above-mentioned embodiments, the lowest-noted sound has been determined as a reference note within one reference section. In addition, the reference note within one reference section may be set to the highest-pitched note within the corresponding reference section. In this case, the reference position in the caption display area may be set to the highest position among the respective display positions.

Also, the highest-pitched or lowest-pitched notes of sounds of audio data within the respective reference sections may be set to a reference note. In this case, the reference position may be determined as the highest position of the caption display area corresponding to the highest-pitched sound, and as the lowest position of the caption display area corresponding to the lowest-pitched sound. Other sounds may be displayed according to a relative pitch difference in a displayer position between the highest position and the lowest position.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

1. A method of generating a caption using lyrics caption data to display a lyrics caption in synchronization with audio data, the method comprising:
dividing the audio data into a plurality of reference sections;
extracting a reference note from notes of the audio data within each of the reference sections;
setting a reference position corresponding to the reference note within a caption display area of a whole screen where the lyrics caption is to be displayed in a vertical direction; and
generating the lyrics caption data such that a lyrics caption corresponding to the reference note within one of the reference sections is displayed on the reference position of the caption display area, and other lyrics captions within the one of the reference section are vertically displayed within the caption display area according to pitch differences from the reference notes.

2. The method of claim 1, wherein the extracting of the reference note comprises extracting a lowest-pitched note of the audio data within the respective reference sections as the reference note, and the setting of the reference position comprises setting the reference position as a lowest position of the caption display area corresponding to the lowest-pitched note.

3. The method of claim 1, wherein the extracting of the reference note comprises extracting a highest-pitched note of the audio data with the respective reference sections as the reference note, and the setting of the reference position comprises setting the reference position as a highest position of the caption display area corresponding to the highest-pitched note.

4. The method of claim 1, wherein the extracting of the reference note comprises extracting a highest-pitched note and a lowest-pitched note of the audio data with the respective reference sections as the reference note, and the setting of the reference position comprises setting the reference position as a highest position of the caption display area corresponding to the highest-pitched note and a lowest position of the caption display area corresponding to the lowest-pitched note, respectively.

5. The method of claim 1, wherein the setting of the reference position comprises setting a plurality of display positions comprising the reference position in the caption display area, and the generating of the lyrics caption data comprises generating the lyrics caption data such that the other captions are displayed on any one of the plurality of display positions according to the pitch differences from the reference note.

6. The method of claim 5, wherein the generating of the lyrics caption data comprises generating the lyrics caption data such that a letter spacing of the lyrics caption displayed in the one of the reference sections corresponds to a relative length of a note with respect to the corresponding lyrics caption.

7. A method of generating a caption using lyrics caption data to display a lyrics caption in synchronization with audio data, the method comprising:
reproducing the audio data in synchronization with the lyrics caption data;
sequentially displaying the lyrics caption extracted from the lyrics caption data on a screen by unit of predetermined reference section; and
displaying the lyrics caption displayed in one of the reference sections on the screen such that relative pitch differences of notes within a reference section corresponding to the audio data reproduced during the reference section are visually distinguished.

8. The method of claim 7, wherein, in the displaying of the lyrics caption, a reference note corresponding to a predetermined reference position among the one of the reference sections is displayed in the reference position within a caption display area in which the lyric caption is to be displayed in a vertical direction, and other lyrics captions within the one of the reference section are vertically displayed within the caption display area according to pitch differences from the reference notes.

9. The method of claim 8, wherein the reference position is set to a lowest position of the caption display area, and the reference note is set to a lowest-pitched note within the one of the reference section.

10. The method of claim 8, wherein the reference position is set to a highest position of the caption display area, and the reference note is set to a highest note within the one of the reference sections.

11. The method of claim 8, wherein the reference position is set to a highest position and a lowest position of the caption display area, and the reference note is set to a highest note and a lowest note within the one of the reference sections corresponding to the highest position and the lowest position.

12. The method of claim 9, wherein a plurality of display positions comprising the reference position are set in the caption display area, and the other captions within the one of the reference sections are displayed on any one of the plurality of display positions according to the pitch differences from the reference note.

13. The method of claim 12, wherein the displaying of the lyrics caption comprises generating the lyrics caption data such that a letter spacing of the lyrics caption displayed in the one of the reference sections corresponds to a relative length of a note with respect to the corresponding lyrics caption.
